(19) United States
(12) Patent Application Publication
(10) Pub. No.: US 2010/0136370 A1
(43) Pub. Date: Jun. 3, 2010

(54) PERPENDICULAR MAGNETIC RECORDING MEDIUM, METHOD OF MANUFACTURING THE SAME, AND MAGNETIC RECORDING/REPRODUCING APPARATUS

(76) Inventors: Ryuji Sakaguchi, Chiba-shi (JP); Gohei Kurokawa, Ichihara-shi (JP); Yuzo Sasaki, Ichihara-shi (JP); Tatsu Komatsuda, Ichihara-shi (JP); Amarendra K. Singh, Jurong (SG)

Correspondence Address: SUGHRUE MION, PLLC, 2100 PENNSYLVANIA AVENUE, N.W., SUITE 800, WASHINGTON, DC, 20037, US

(21) Appl. No.: 12/530,423

(22) PCT Filed: Feb. 19, 2008
(86) PCT No.: PCT/JP2008/052716

§ 371 Date: Sep. 8, 2009

(30) Foreign Application Priority Data
Mar. 9, 2007 (JP) 2007-060653

(51) Int. Cl. G11B 5/33

(52) U.S. Cl. 428/810; 428/800; 977/773

(57) ABSTRACT

The present invention provides a magnetic recording medium capable of reducing the diameter of particles of a perpendicular magnetic recording layer and obtaining a high perpendicular orientation to enable information to be recorded or reproduced at a high density, a method of manufacturing the same, and a magnetic recording/reproducing apparatus. A perpendicular magnetic recording medium includes a non-magnetic substrate; and at least a soft magnetic layer, an underlayer, an intermediate layer, and a perpendicular magnetic recording layer that are formed on the non-magnetic substrate in this order. The underlayer is a (111) crystal orientation layer having an fcc structure, and the intermediate layer includes a (110) crystal orientation layer having a bcc structure and a (002) crystal orientation layer having an hcp structure in this order. The (110) crystal orientation layer having the bcc structure includes 60 at % or more of Cr.

### TECHNICAL FIELD

The present invention relates to a perpendicular magnetic recording medium, a method of manufacturing the same, and a magnetic recording/reproducing apparatus using the magnetic recording medium.

Priority is claimed on Japanese Patent Application No. 2007-060653, filed Mar. 9, 2007, the content of which is incorporated herein by reference.

### BACKGROUND ART

In recent years, the application range of magnetic recording apparatuses, such as magnetic disk apparatuses, flexible disk apparatuses, and magnetic tape apparatuses, has increased remarkably, and the importance thereof has increased. Therefore, a technique for significantly improving the recording density of magnetic recording media used for these apparatuses has been developed. In particular, the development of an MR head and a PRML technique has accelerated improvements in the surface recording density. In recent years, with the development of a GMR head and a TuMR head, the recording density has increased at a rate of about 100 percent per year.

In addition, there is a demand for further increase in the recording density of the magnetic recording media. In order to meet such demand, it is necessary to improve the coercivity, the signal-to-noise ratio (S/N ratio), and the resolution of a magnetic recording layer. In a longitudinal magnetic recording type that has generally been used, with an increase in linear recording density, recording magnetic domains adjacent to magnetization transition regions mutually weaken their magnetizations, which is called self-demagnetization. In order to prevent self-demagnetization, it is necessary to reduce the thickness of the magnetic recording layer to increase shape magnetic anisotropy.

When the thickness of the magnetic recording layer is reduced, the strength of an energy barrier for maintaining the magnetic domain is substantially equal to that of the thermal energy, and the phenomenon in which the amount of recorded magnetization is reduced due to a temperature variation (heat fluctuation phenomenon) is not negligible, which determines the limit of the linear recording density.

In recent years, an AFC (anti-ferromagnetic coupling) medium has been proposed as the technology of improving the linear recording density of the longitudinal magnetic recording type, trying to solve the problem of reduction in thermomagnetism in the longitudinal magnetic recording type.

As a technique for improving surface recording density, a perpendicular magnetic recording type has drawn attention. In the longitudinal magnetic recording type according to the related art, a medium is magnetized in the in-plane direction. However, in the perpendicular magnetic recording type, a medium is magnetized in the perpendicular direction of the surface of the medium. In this way, it is possible to avoid the self-demagnetization that prevents an increase in linear recording density in the longitudinal magnetic recording type. Therefore, the perpendicular magnetic recording type is applicable to obtain high recording density. In addition, since the perpendicular magnetic recording type can maintain the thickness of the magnetic layer to be constant, it is possible to relatively reduce the effect of the thermomagnetism caused in the longitudinal magnetic recording type.

In general, a perpendicular magnetic recording medium is formed by sequentially laminating an underlayer, an intermediate layer, a magnetic recording layer, and a protective layer on a non-magnetic substrate. In general, after the protective layer is formed, a lubrication layer is formed on the protective layer. In addition, in many cases, a magnetic layer, which is a soft magnetic soft magnetic layer, is provided below the underlayer. The intermediate layer is formed in order to improve the characteristics of the magnetic recording layer. In addition, the underlayer functions to align the crystal particles of the intermediate layer and the magnetic recording layer and control the shape of a magnetic crystal.

The crystal structure of the magnetic recording layer is important to manufacture a perpendicular magnetic recording medium with good characteristics. That is, in the perpendicular magnetic recording medium, generally, the crystal structure of the magnetic recording layer is an hcp structure. It is important that a (002) crystal plane be parallel to the surface of the substrate, that is, a crystal c-axis ([002] axis) be aligned in the perpendicular direction with the least possible disorder.

In order to align the crystal particles of the magnetic recording layer with the least possible disorder, the intermediate layer of the perpendicular magnetic recording medium has been made of Ru having the same hcp structure as the magnetic recording layer according to the related art. Since the crystal of the magnetic recording layer is epitaxially grown on the (002) crystal plane of Ru, a magnetic recording medium with a good crystal orientation can be obtained (for example, see Patent Document 1).

That is, when the (002) crystal plane orientation of the Ru intermediate layer is improved, the orientation of the magnetic recording layer is also improved. Therefore, it is necessary to improve the (002) orientation of Ru in order to improve the recording density of the perpendicular magnetic recording medium. However, when Ru is directly deposited on an amorphous soft magnetic layer, the thickness of the Ru layer is too large to obtain good crystal orientation, and Ru, which is a non-magnetic material, reduces the tension of the magnetic field from the head to the soft magnetic layer, which is a soft magnetic material. Therefore, in the related art, an underlayer having an fcc (111) crystal plane orientation is inserted between the soft magnetic layer and the Ru intermediate layer (for example, see Patent Document 2). The underlayer having the fcc structure has a high crystal orientation even though the thickness thereof is small. Ru deposited on the underlayer having the fcc structure has a smaller thickness and a higher crystal orientation than Ru directly deposited on the soft magnetic layer. However, since it is difficult to control the diameters of the crystal particles of Ru on the underlayer having the fcc structure, the particle diameter increases, which results in an increase in the diameter of the crystal particles of a Co alloy deposited on the Ru intermediate layer. As a result, the amount of noise increases and recording/reproducing characteristics deteriorate.

In order to improve the recording/reproducing characteristics, it is necessary to obtain a perpendicular magnetic recording medium capable of reducing the diameters of the crystal particles and obtaining a high perpendicular orientation and having good recording/reproducing characteristics. Therefore, a perpendicular magnetic recording medium is required which can solve the above-mentioned problems and can be easily manufactured.

[Patent Document 1] JP-A-2001-6158

[Patent Document 2] JP-A-2005-190517

### DISCLOSURE OF THE INVENTION

### Problems that the Invention is to Solve

The present invention has been made in order to solve the above problems, and an object of the present invention is to provide a magnetic recording medium that can reduce the diameters of particles of a perpendicular magnetic recording layer and obtain a high perpendicular orientation, thereby enabling information to be recorded or reproduced at a high density, a method of manufacturing the same, and a magnetic recording/reproducing apparatus.

### Means for Solving the Problems

In order to achieve the object, the present invention has the following structure.

According to a first aspect of the present invention, a perpendicular magnetic recording medium includes: a non-magnetic substrate; and at least a soft magnetic layer, an underlayer, an intermediate layer, and a perpendicular magnetic recording layer that are formed on the non-magnetic substrate in this order. The underlayer is a (111) crystal orientation layer having an fcc structure, and the intermediate layer includes a (110) crystal orientation layer having a bcc structure and a (002) crystal orientation layer having an hcp structure in this order.

According to a second aspect of the present invention, in the magnetic recording medium according to the first aspect, the (110) crystal orientation layer having the bcc structure may include 60 at % or more of Cr.

According to a third aspect of the present invention, in the magnetic recording medium according to the first or second aspect, the (110) crystal orientation layer having the bcc structure may include Cr, which is a main component, and at least one element selected from the group consisting of Pt, Ir, Pd, Au, Ni, Al, Ag, Cu, Rh, Pb, Co, Fe, Mn, V, Nb, Ta, Mo, W, B, C, Si, Ga, In, Ti, Zr, Hf, Ru, and Re.

According to a fourth aspect of the present invention, in the magnetic recording medium according to any one of the first to third aspects, the diameter of the crystal particles of the (110) crystal orientation layer having the bcc structure may be in the range of 3 nm to 10 nm.

According to a fifth aspect of the present invention, in the magnetic recording medium according to any one of the first to fourth aspects, the thickness of the (110) crystal orientation layer having the bcc structure may be in the range of 1 nm to 50 nm.

According to a sixth aspect of the present invention, in the magnetic recording medium according to any one of the first to fifth aspects, a soft magnetic layer of the soft magnetic layer may have an amorphous structure.

According to a seventh aspect of the present invention, in the magnetic recording medium according to any one of the first to sixth aspects, the (111) crystal orientation layer having the fcc structure may include one alloy selected from a group composed of Ni, NiW, NiFe, NiV, and NiNb.

According to an eighth aspect of the present invention, in the magnetic recording medium according to any one of the first to seventh aspects, the (002) crystal orientation layer having the hcp structure may include Ru or a Ru alloy.

According to a ninth aspect of the present invention, in the magnetic recording medium according to any one of the first to eighth aspects, at least one layer of the perpendicular magnetic recording layer may be an oxide-containing magnetic layer or a layer formed by continuously depositing Co and Pd.

According to a tenth aspect of the present invention, a magnetic recording/reproducing apparatus includes: the magnetic recording medium according to any one of the first to ninth aspects; and a magnetic head that records or reproduces information on or from the magnetic recording medium.

### Advantages of the Invention

According to the present invention, it is possible to provide a perpendicular magnetic recording medium with high recording density in which the crystal c-axis of the crystal structure of a perpendicular magnetic layer, particularly, an hcp structure is aligned with the surface of a substrate with a very small angle dispersion and the average diameter of crystal particles of the perpendicular magnetic layer is very small.

### BRIEF DESCRIPTION OF THE DRAWINGS

FIG. 1 is a cross-sectional view illustrating the structure of a perpendicular magnetic recording medium according to the present invention;

FIG. 2 is a diagram illustrating the (111) plane orientation of an fcc structure;

FIG. 3 is a diagram illustrating the (002) plane orientation of an hcp structure;

FIG. 4 is a diagram illustrating the (110) plane orientation of a bcc structure; and

FIG. 5 is a diagram illustrating the structure of a perpendicular magnetic recording/reproducing apparatus according to the present invention.

### REFERENCE NUMERALS

1: Non-magnetic substrate

2: Soft magnetic soft magnetic layer

3: Underlayer

4: Intermediate layer

5: Perpendicular magnetic layer

6: Protective layer

10: Perpendicular magnetic recording medium

11: Medium driving unit

12: Magnetic head

13: Head driving unit

14: Recording/reproducing signal processing system

### BEST MODE FOR CARRYING OUT THE INVENTION

Hereinafter, the content of the present invention will be described in detail.

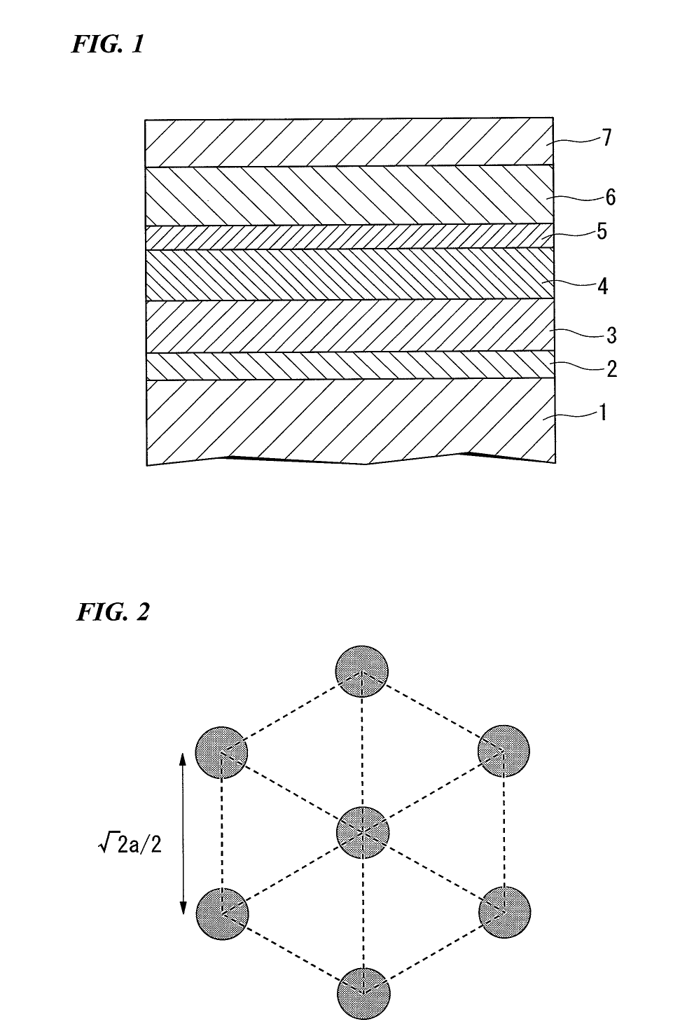

As shown in FIG. 1, a perpendicular magnetic recording medium according to the present invention includes at least a soft magnetic soft magnetic layer 2, an underlayer 3 and a first intermediate layer 4 forming an orientation control layer that controls the orientation of an upper layer, a second intermediate layer 5, a perpendicular magnetic layer 6 having an easy magnetization axis (crystal c-axis) that is substantially perpendicular to a substrate, and a protective layer 7, which are formed on a non-magnetic substrate 1. The orientation control layer includes a plurality of layers. The orientation control layer can also be applied to new perpendicular recording media that is expected to improve recording density in the near future, such as ECC media, discrete track media, and pattern media.

As the non-magnetic substrate used for the magnetic recording medium according to the present invention, any of the following non-magnetic substrates may be used: an Al alloy substrate made of, for example, an Al—Mg alloy having Al as a main component; a general soda glass substrate; an aluminosilicate-based glass substrate; an amorphous glass-based substrate; a silicon substrate; a titanium substrate; a ceramics substrate; a sapphire substrate; a quartz substrate; and substrates made of various kinds of resins. Among these substrates, in many cases, an Al alloy substrate or a glass-based substrate, such as a glass ceramics substrate or an amorphous glass substrate, is used as the non-magnetic substrate. In the case of the glass substrate, it is preferable to use a mirror-polished substrate or a substrate having a low Ra (Ra<1 (Å)). The non-magnetic substrate may include a little texture.

In a process of manufacturing a magnetic disk, it is common to firstly clean and dry a substrate. In the present invention, it is also preferable to clean and dry a substrate before a magnetic disk manufacturing process, in order to improve the adhesion between the layers. The cleaning processes include a cleaning process using etching (reverse sputtering) as well as a water cleaning process. In addition, the size of the substrate is not particularly limited.

Next, the layers of the perpendicular magnetic recording medium will be described.

The soft magnetic soft magnetic layer is generally provided in the perpendicular magnetic recording medium. In order to record signals on a medium, a recording magnetic field is generated from a head, and a perpendicular component of the recording magnetic field is effectively applied to a magnetic recording layer. The soft magnetic soft magnetic layer may be made of a material having so-called soft magnetic characteristics, such as a FeCo-based alloy, a CoZrNb-based alloy, or a CoTaZr-based alloy. It is preferable that the soft magnetic soft magnetic layer have an amorphous structure. When the soft magnetic soft magnetic layer has an amorphous structure, it is possible to prevent an increase in surface roughness (Ra) and reduce the lift of the head. In addition, it is possible to improve recording density. In recent years, in addition to a single soft magnetic layer, a structure in which a very thin non-magnetic layer made of, for example, Ru is interposed between two layers to form an AFC magnetic layer between soft magnetic layers has come into widespread use. The overall thickness of the soft magnetic layer is in the range of about 20 (nm) to 120 (nm), but it is appropriately determined by the balance between recording/reproducing characteristics and OW characteristics.

In the present invention, the orientation control layer that controls the orientation of the upper layer is provided on the soft magnetic soft magnetic layer. The orientation control layer has a multi-layer structure of an underlayer and an intermediate layer formed on the substrate in this order.

In the present invention, it is preferable that the underlayer have a face-centered cubic lattice structure (fcc structure) that has a high orientation control capability even when the thickness of the layer is small and the average diameter of the crystal particles of the underlayer are in the range of 6 (nm) to 20 (nm). In addition, the first intermediate layer on the underlayer has a body-centered cubic lattice structure (bcc structure) and the second intermediate layer that comes into contact with an upper magnetic recording layer has a hexagonal close-packed lattice structure (hcp structure).

The fcc structure, the bcc structure, and the hcp structure of materials forming the underlayer and the intermediate layers defined by the present invention indicate crystal structures in an environment in which the magnetic recording medium according to the present invention is used, that is, the crystal structures at room temperature, in view of the object of the present invention.

The intermediate layer according to the present invention includes the first intermediate layer having a bcc (110) crystal orientation that is provided between the underlayer having an fcc (111) crystal orientation and the second intermediate layer having an hcp (002) crystal orientation.

The crystal orientation of the magnetic recording layer formed on the intermediate layer is substantially determined by the crystal orientation of the intermediate layer. Therefore, it is very important to control the orientation of the intermediate layer in a method of manufacturing the perpendicular magnetic recording medium. Similarly, if it is possible to finely control the average diameter of the crystal particles of the intermediate layer, the crystal particles of the magnetic recording layer continuously formed on the intermediate layer are likely to succeed to the shape of the crystal particles of the intermediate layer, and the magnetic recording layer is likely to have fine crystal particles. Therefore, it has been found that the smaller the diameter of the crystal particles of the magnetic recording layer becomes, the higher the signal-to-noise ratio (SNR) becomes.

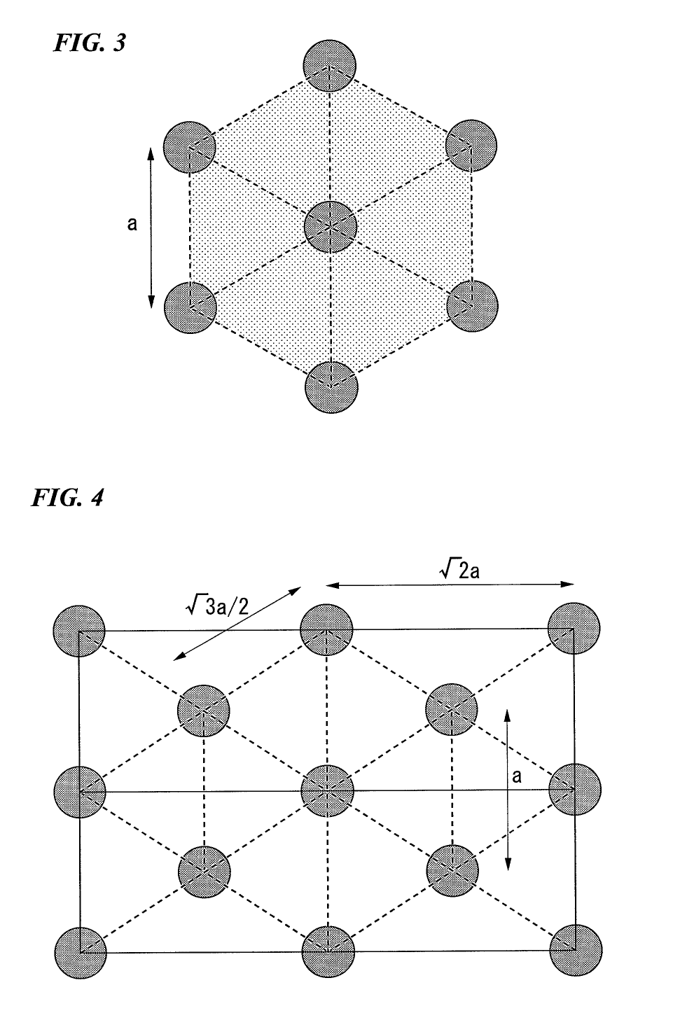

The (111) crystal plane of the fcc structure is a regular hexagon in which the length of one side is √2a/2 (a: a lattice constant), as shown in FIG. 2. In the fcc crystal, since the (111) plane is a close-packed plane, the (111) crystal plane is preferentially oriented on an amorphous soft magnetic soft magnetic layer. FIG. 3 shows the image of the (002) crystal plane of the hcp structure. Similar to the fcc (111) crystal plane, the hcp (002) crystal plane is a regular hexagon in which the length of one side is a. Since the hcp (002) crystal plane is also a close-packed plane, it is likely to be preferentially oriented. Since the hcp (002) crystal plane has a regular hexagonal shape, the hcp (002) crystal plane on the fcc (111) crystal plane may have a high crystal orientation even though it does not have a large thickness. In the related art, in order to improve crystal orientation, a material in which the lattice constant (√2a/2) of the fcc crystal is close to the lattice constant (a) of the hcp crystal is selected.

However, in order to improve the recording density of the perpendicular magnetic recording medium, it is necessary not only to improve the crystal orientation but also to reduce the diameters of the crystal particles of the magnetic recording layer. In the fcc (111) crystal plane and the hcp (002) crystal plane obtained by laminating the regular hexagons, since the crystals are laminated and grown without any disorder, the orientation thereof is improved, but it is difficult to control the diameters of the crystal particles. In addition, while the crystals are being grown, the crystals are weeded out, and a particle diameter distribution is widened, which makes it difficult to improve the recording density.

FIG. 4 shows the bcc (110) crystal plane introduced as the first intermediate layer in the present invention. As can be seen from FIG. 4, unlike the fcc (111) crystal plane or the hcp (002) crystal plane, the bcc (110) crystal plane does not have a regular hexagonal shape (among the lengths of six sides, two sides have a length of a and the other four sides have a length of √3a/2). In the bcc crystal, since the (110) crystal plane is a close-packed plane, the (110) crystal plane is preferentially oriented on the fcc (111) crystal plane of the underlayer. However, unlike the hcp structure on the fcc structure, since the bcc crystal does not have a regular hexagonal shape, mismatching between the shapes hinders the growth of the crystal. However, this mismatching contributes to controlling the diameters of the crystal particles. It is possible to improve the crystal orientation by balancing the lattice constant of the fcc crystal with the lattice constant of the bcc crystal. Specifically, it is possible to obtain the same crystal orientation as that in a laminate of the fcc structure and the hcp structure by selecting a material allowing the area of the hexagon shown in FIG. 2 to be as close to the area of the hexagon shown in FIG. 4 as possible. The same mismatching as described above occurs between the first intermediate layer having a bcc (110) orientation and the second intermediate layer having an hcp (002) orientation, which contributes to controlling the diameters of the crystal particles.

In this way, the diameters of the crystal particles of the magnetic recording layer formed on the second intermediate layer having the hcp (002) crystal orientation are controlled. Therefore, for orientation, the crystal c-axis ([002] axis) is effectively oriented in the perpendicular direction to the substrate.

In the perpendicular magnetic recording medium, a method of using the half-width of a rocking curve may be used as a method of evaluating whether the crystal c-axis ([002] axis) of the magnetic recording layer is oriented in the perpendicular direction to the substrate with the least possible disorder. First, a substrate having a layer formed thereon is placed on an X-ray diffractometer, and a crystal plane that is parallel to the surface of the substrate is analyzed by the X-ray diffractometer. X-rays are radiated to the substrate at a predetermined incident angle to observe a diffraction peak corresponding to the crystal plane. When the magnetic recording medium is made of a Co alloy, the c-axis [002] direction of the hcp structure is perpendicularly aligned with respect to the surface of the substrate. Therefore, a peak corresponding to the (002) plane is observed. Then, an optical system is swung relative to the surface of the substrate while maintaining the Bragg angle with respect to the (002) plane. In this case, when the diffraction intensity of the (002) plane with respect to the inclination angle of the optical system is plotted, it is possible to draw a diffraction intensity curve having a swing angle of 0° as its center, which is called a rocking curve. In this case, when the (002) plane is substantially parallel to the surface of the substrate, a sharp rocking curve is obtained. On the other hand, when the direction of the (002) plane is widely spread, a broad rocking curve is obtained. Therefore, in many cases, the half-width Δ (delta) θ50 of the rocking curve is used as an index for the crystal orientation of the perpendicular magnetic recording medium.

According to the present invention, the underlayer having a (111) crystal plane orientation that is made of an element having the fcc structure or an alloy thereof is provided, and the first intermediate layer having a (110) crystal plane orientation that is made of an element having the bcc structure or an alloy thereof is provided on the underlayer. In addition, the second intermediate layer having a (002) crystal plane orientation that is made of an element having the hcp structure or an alloy thereof is provided on the first intermediate layer. Therefore, it is possible to manufacture a perpendicular magnetic recording medium having a small half-width of Δθ50, as compared to a medium using only the intermediate layer made of an element having the hcp structure.

Signals are actually recorded on the magnetic recording layer. The magnetic recording layer is generally made of a Co-based alloy, such as CoCr, CoCrPt, CoCrPtB, CoCrPtB—X, CoCrPtB—X—Y, CoCrPt—O, CoCrPt—SiO₂, CoCrPt—Cr₂O₃, CoCrPt—TiO₂, CoCrPt—ZrO₂, CoCrPt—Nb₂O₅, CoCrPt—Ta₂O₅, or CoCrPt—TiO₂. In particular, when a magnetic oxide layer is used, a granular structure in which an oxide surrounds magnetic Co crystal particles is obtained, and magnetic interaction between the Co crystal particles is weakened, which results in a reduction in noise. Finally, the crystal structure and the magnetic characteristics of the layer determine recording/reproducing characteristics.

Since the magnetic recording layer has a granular structure, it is preferable to increase the pressure of the gas when forming the intermediate layer to form uneven portions on the surface of the layer. In this case, the oxide of the magnetic oxide layer is concentrated on the concave portions of the surface of the intermediate layer, thereby forming the granular structure. However, when the gas pressure is increased, the crystal orientation of the intermediate layer is likely to deteriorate, and the surface roughness may be increased. Therefore, in order to improve an orientation property and reduce the surface roughness, the first intermediate layer is formed at a low gas pressure, and the second intermediate layer is formed at a high gas pressure.

In general, a DC magnetron sputtering method or an RF sputtering method is used to form the above-mentioned layers. In addition, an RF bias, a DC bias, a pulsed DC, a pulsed DC bias, O₂ gas, H₂O gas, and N₂ gas may be used. In this case, a sputtering gas pressure is appropriately determined such that each layer has the optimal characteristics. In general, the sputtering gas pressure is controlled substantially in the range of 0.1 to 30 (Pa). The sputtering gas pressure is appropriately adjusted depending on the performance of a medium.

The protective layer is provided to protect the recording medium from the damage caused by contact between the head and the medium. For example, a carbon layer or a SiO₂ layer is used as the protective layer. In many cases, the carbon layer is used as the protective layer. For example, a sputtering method or a plasma CVD method is used to form the protective layer. In recent years, the plasma CVD method has generally been used. A magnetron plasma CVD method may also be used. The thickness of the protective layer is preferably in the range of about 1 (nm) to 10 (nm), more preferably, in the range of about 2 (nm) to 6 (nm), and most preferably, in the range of about 2 (nm) to 4 (nm).

In particular, it is possible to manufacture a magnetic recording medium with little noise in which a magnetic crystal is isolated by an oxide while maintaining crystal orientation by adjusting the pressure of the gas when forming the intermediate layer and the pressure of gas when forming the magnetic recording layer.

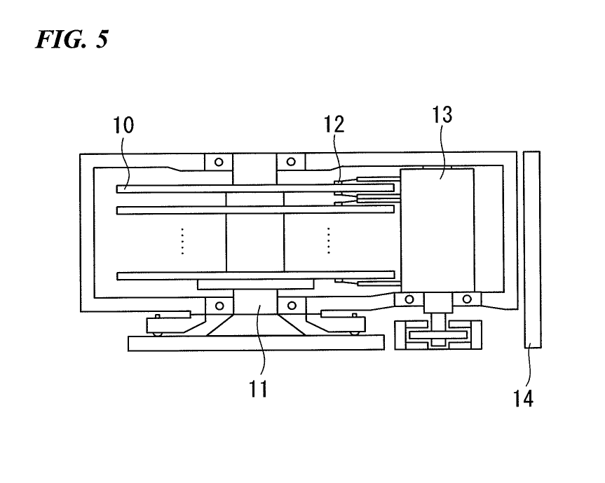

FIG. 5 is a diagram illustrating an example of a perpendicular magnetic recording/reproducing apparatus using the perpendicular magnetic recording medium. The magnetic recording/reproducing apparatus shown in FIG. 5 includes the magnetic recording medium 10 shown in FIG. 1, a medium driving unit 11 that rotates the recording medium 10, a magnetic head 12 that records or reproduces information on or from the magnetic recording medium 10, a head driving unit 13 that moves the magnetic head 12 relative to the magnetic recording medium 10, and a recording/reproducing signal processing system 14.

The recording/reproducing signal processing system 14 can process data input from the outside and transmit recording signals to the magnetic head 12. In addition, the recording/reproducing signal processing system 14 can process reproduction signals from the magnetic head 12 and transmit data to the outside.

As the magnetic head 12 used for the magnetic recording/reproducing apparatus according to the present invention, the following may be used: a magnetic head that includes, as a reproducing element, a magneto-resistance (MR) element using an anisotropic magneto-resistance effect (AMR), a giant magneto-resistance (GMR) element using a GMR effect, or a TuMR element using a tunnel effect, and is applicable to improve recording density.

### Examples

Hereinafter, the present invention will be described in detail with reference to examples.

### Example 1 and Comparative Example 1

A vacuum chamber having an HD glass substrate set therein was evacuated to a pressure of 1.0×10⁻⁵ (Pa) or less.

Then, a soft magnetic soft magnetic layer that was made of CoNbZr with a thickness of 50 (nm) and an underlayer that had the fcc structure and was made of NiFe with a thickness of 5 (nm) were formed on the substrate in an Ar atmosphere at a gas pressure of 0.6 (Pa) by a sputtering method.

A first intermediate layer was made of Ru having the hcp structure, an element Cr having the bcc structure, and Cr alloys, such as Cr—B, Cr—Mn, Cr—Mo, and Cr—Ti (Cr>60(%)) (Comparative example 1-1 and Examples 1-1 to 1-13). As a comparative example, the first intermediate layer was made of a Cr alloy (Cr>60(%)) (Comparative examples 1-2 to 1-8). In order to mix Cr, the substrate was rotated during a deposition process. The distance from the rotation center of a substrate holder to the center of the substrate was 396 (mm), and the number of rotations of the substrate holder was 160 (rpm) during the deposition process. During the deposition process, the discharge powers of two targets were arbitrarily adjusted to control the Cr concentration in the layer. The relationship between the film deposition speed and the discharge power of each target was checked, and the composition of the Cr alloy was calculated from the discharge power and the discharge time during the deposition process. The thickness of the first intermediate layer was adjusted to 10 (nm). Then, the second intermediate layer made of Ru having the hcp structure was formed in an Ar atmosphere at a gas pressure of 10 (Pa).

In Example 1 and Comparative example 1, a magnetic recording layer made of Co—Cr—Pt—SiO₂ and a protective layer made of C were formed to manufacture a perpendicular magnetic recording medium.

A lubricant was applied onto the obtained perpendicular magnetic recording medium and the recording/reproducing characteristics of the perpendicular magnetic recording medium were evaluated using Read/Write Analyzer 1632 and Spin Stand S1701MP available from Guzik Technical Enterprises of the USA. Then, the static magnetic characteristics of the perpendicular magnetic recording medium were evaluated by a Kerr measuring apparatus.

In order to examine the crystal orientation of a Co-based alloy forming the magnetic recording layer, the rocking curve of the magnetic layer was measured by an X-ray diffractometer. In addition, in the examples, for the samples having good recording/reproducing characteristics, the diameters of the crystal particles of the Co-based alloy forming the magnetic recording layer were observed by TEM.

In order to check the orientation of the first intermediate layer, in Examples 1-1 to 1-13 and Comparative examples 1-1 to 1-5, the first intermediate layer was formed with a thickness of 20 nm, and the bcc (110) orientation of the first intermediate layer was examined.

The measured results are shown in Table 1.

As can be seen from the examples shown in Table 1, when the content of Cr was equal to or greater than 80(%), the parameters of Ru having the hcp structure, such as SNR Hc, and Δθ50, were improved. In addition, fine crystal particles having a diameter smaller than those of the crystal particles of Ru were obtained.

When the first intermediate layer was made of Cr—B, Cr—Mn, or Cr—Ti and the content of each element added was increased, the peak intensity of the bcc (110) crystal plane was reduced. Finally, the peak is not observed. That is, it is considered that, when the content of an element added is increased, the bcc (110) crystal orientation is broken, and the characteristics of each parameter in Table 1 are lowered. For Cr—Mo, since Mo is an element having the bcc structure, the bcc structure was maintained even when the content of Mo was increased. Therefore, a diffraction peak was observed as shown in Table 1. In the fcc (111) crystal plane and the bcc (110) crystal plane having hexagonal shapes shown in FIGS. 2 and 4, when the areas of NiFe, Cr, and Mo are calculated from their lattice constants, the area of Cr is substantially equal to that of NiFe, but the area of Mo is considerably larger than that of NiFe. That is, when the content of Mo in Cr—Mo is increased, large lattice mismatching occurs between the underlayer and the first intermediate layer. As a result, orientation deteriorates, and the SNR is lowered.

### Example 2 and Comparative Example 2

Similar to Example 1, a soft magnetic layer was formed on a glass substrate. An underlayer was made of NiFe with a thickness of 5 (nm) (Example 2-1). In addition, layers were made of alloys obtained by adding 0, 10, and 20% of W, which was a bcc element, to Ni, which was is an fcc element, with a thickness of 5 (nm) (Examples 2-2 to 2-4). Then, a first intermediate layer was made of Cr with a thickness of 10 (nm) at a gas pressure of 0.6 (Pa), and a second intermediate layer was made of Ru with a thickness of 10 (nm) at a gas pressure of 10 (Pa). As comparative examples, underlayers were made of Ni-50 W having an amorphous structure and W having the bcc structure with a thickness of 5 (nm) (Comparative examples 2-1 to 2-3).

In order to observe the crystal orientation of the first intermediate layer on the underlayer, the first intermediate layers made of only Cr were formed with a thickness of 20 nm on the underlayers having the compositions according to Examples 2-1 to 2-4 and Comparative examples 2-1 to 2-3, and the bcc (110) orientation of each first intermediate layer was examined.

Then, similar to Example 1, a magnetic recording layer made of Co—Cr—Pt—SiO₂ and a protective layer made of C were formed on the surface of the sample to manufacture a perpendicular magnetic recording medium. Then, various measurements were performed, and the measurement results, such as the signal-to-noise ratio (SNR), coercivity (Hc), and Δθ50, are shown in Table 2. In addition, the bcc (110) crystal orientation of the sample having a layer made of Cr with a thickness 20 (nm) was examined, and the value of Δθ50 of the Cr (110) crystal plane is shown in Table 2.

As can be seen from Table 2, when the underlayer is not provided or when W>20(%), the static magnetic/electromagnetic characteristics and the crystal orientation of the magnetic recording layer are lowered. The reason is as follows. As can be seen from Table 2, in the case of the underlayer that does not have the fcc structure, the (110) crystal orientation of Cr in the first intermediate layer is lowered, and the static magnetic/electromagnetic characteristics and the crystal orientation of the magnetic recording layer are lowered.

### Example 3 and Comparative Example 3

Similar to Examples 1 and 2, a soft magnetic layer was formed on a glass substrate. An underlayer was made of NiFe having the fcc structure with a thickness of 5 (nm) in an Ar atmosphere at a gas pressure of 0.6 (Pa).

A first intermediate layer was made of Cr having a bcc structure with a thickness of 10 (nm) in an Ar atmosphere at a gas pressure of 0.6 (Pa). Second intermediate layers made of Ru having the hcp structure, Cr having a bcc structure, and Ni having an fcc structure were formed on the first intermediate layers with a thickness of 10 (nm) (Example 3-1 and Comparative examples 3-1 and 3-2).

Then, a magnetic recording layer made of Co—Cr—Pt—SiO₂ and a protective layer made of C were formed on the surface of each of the samples to manufacture a magnetic recording medium. Then, various measurements were performed, and the measurement results, such as the signal-to-noise ratio (SNR), coercivity (Hc), and Δθ50, are shown in Table 3.

As can be seen from Table 3, Ru having the same hcp (002) crystal orientation as a Co alloy is most suitable for a layer below the magnetic recording layer. When the intermediate layer is made of only Cr, Co is not oriented, and the characteristics of the intermediate layer are significantly lowered. When the intermediate layer is made of Ni, the hcp (002) crystal plane is easily oriented on the fcc (111) crystal plane, but the characteristics of the Ni intermediate layer are less than those of the Ru intermediate layer.

TABLE 1

| | | | | | | Average | (002) | (110) | |
|---|---|---|---|---|---|---|---|---|---|
| | | | | | | particle | orientation | orientation | |
| | | First | Second | | | diameter of | of | position of | |
| | | intermediate | intermediate | | | first | magnetic | first | Peak |
| | Underlayer | layer | layer | SNR | | intermediate | layer Δθ50 | intermediate | intensity |
| Sample | (structure) | (structure) | (structure) | (dB) | Hc (Oe) | layer (nm) | (°) | layer (deg.) | (cps) |
| Comparative | NiFe (fcc) | Ru (hcp) | Ru (hcp) | 15.6 | 4468 | 7.6 | 3.3 | No peak | — |
| example 1-1 | | | | | | | | | |
| Example 1-1 | NiFe (fcc) | Cr (bcc) | Ru (hcp) | 15.8 | 4730 | 7.3 | 3 | 44.5 | 17000 |
| Example 1-2 | NiFe (fcc) | Cr—10B | Ru (hcp) | 16 | 4561 | 7.2 | 3.2 | 44.6 | 15000 |
| | | (bcc) | | | | | | | |
| Example 1-3 | NiFe (fcc) | Cr—20B | Ru (hcp) | 15.7 | 4209 | | 3.2 | 44.6 | 11000 |
| | | (bcc) | | | | | | | |
| Example 1-4 | NiFe (fcc) | Cr—42B | Ru (hcp) | 11.7 | 3158 | | 6.8 | 44.8 | 4000 |
| | | (bcc) | | | | | | | |
| Comparative | NiFe (fcc) | Cr—50B | Ru (hcp) | 0 | 1593 | | No peak | No peak | — |
| example 1-2 | | | | | | | | | |
| Example 1-5 | NiFe (fcc) | Cr—10Mn | Ru (hcp) | 16.2 | 4619 | 7.3 | 3.1 | 44.8 | 21000 |
| | | (bcc) | | | | | | | |
| Example 1-6 | NiFe (fcc) | Cr—20Mn | Ru (hcp) | 16.2 | 4349 | | 3.2 | 44.9 | 18000 |
| | | (bcc) | | | | | | | |
| Example 1-7 | NiFe (fcc) | Cr—42Mn | Ru (hcp) | 14.1 | 3811 | | 4.2 | 45.1 | 5500 |
| | | (bcc) | | | | | | | |
| Comparative | NiFe (fcc) | Cr—50Mn | Ru (hcp) | 0 | 2042 | | No peak | No peak | — |
| example 1-3 | | | | | | | | | |
| Example 1-8 | NiFe (fcc) | Cr—10Mo | Ru (hcp) | 15.9 | 4629 | 7.2 | 3.1 | 43.8 | 16000 |
| | | (bcc) | | | | | | | |
| Example 1-9 | NiFe (fcc) | Cr—20Mo | Ru (hcp) | 15.7 | 4184 | | 3.3 | 43.3 | 13000 |
| | | (bcc) | | | | | | | |
| Example | NiFe (fcc) | Cr—42Mo | Ru (hcp) | 13.3 | 3512 | | 5.3 | 42.9 | 15000 |
| 1-10 | | (bcc) | | | | | | | |
| Comparative | NiFe (fcc) | Cr—50Mo | Ru (hcp) | 0 | 1677 | | No peak | 42.3 | 16000 |
| example 1-4 | | | | | | | | | |
| Example | NiFe (fcc) | Cr—10Ti | Ru (hcp) | 15.9 | 4591 | 7.4 | 3 | 44.2 | 17000 |
| 1-11 | | (bcc) | | | | | | | |
| Example | NiFe (fcc) | Cr—20Ti | Ru (hcp) | 15.7 | 4206 | | 3.2 | 43.8 | 13000 |
| 1-12 | | (bcc) | | | | | | | |
| Example | NiFe (fcc) | Cr—42Ti | Ru (hcp) | 12.8 | 3548 | | 5.1 | 43.5 | 4000 |
| 1-13 | | (bcc) | | | | | | | |
| Comparative | NiFe (fcc) | Cr—50Ti | Ru (hcp) | 0 | 2015 | | No peak | No peak | — |
| example 1-5 | | | | | | | | | |

TABLE 2

| | | | | | | | (002) | (110) |
|---|---|---|---|---|---|---|---|---|
| | | | | | | | orientation | orientation of |
| | | Thickness | First | Second | | | of | first |
| | | of | intermediate | intermediate | | | magnetic | intermediate |
| | Underlayer | filmlayer | layer | layer | | | layer Δθ50 | layer Δθ50 |
| Sample | (structure) | (Å) | (structure) | (structure) | SNR (dB) | Hc (Oe) | (°) | (°) |
| Example 2-1 | NiFe (fcc) | 50 | Cr (bcc) | Ru (hcp) | 15.8 | 4761 | 3 | 3.5 |
| Example 2-2 | Ni (fcc) | 50 | Cr (bcc) | Ru (hcp) | 15.1 | 4982 | 2.7 | 3.1 |
| Example 2-3 | Ni—10W | 50 | Cr (bcc) | Ru (hcp) | 16.3 | 4677 | 2.9 | 3.3 |
| | (fcc) | | | | | | | |
| Example 2-4 | Ni—20W | 50 | Cr (bcc) | Ru (hcp) | 15.6 | 4051 | 3.5 | 4.6 |
| | (fcc) | | | | | | | |
| Comparative | — | — | Cr (bcc) | Ru (hcp) | 0 | 2774 | No peak | Measurement |
| example 2-1 | | | | | | | | unavailable |
| Comparative | Ni-50W | 50 | Cr (bcc) | Ru (hcp) | 11 | 2854 | 7.3 | Measurement |
| example 2-2 | (amorphous) | | | | | | | unavailable |
| Comparative | W (bcc) | 50 | Cr (bcc) | Ru (hcp) | 0 | 1348 | No peak | 7.4 |
| example 2-3 | | | | | | | | |

TABLE 3

| | | | | | | (002) |
|---|---|---|---|---|---|---|
| | | First | Second | | | orientation |
| | | intermediate | intermediate | | | of magnetic |
| | Underlayer | layer | layer | SNR | Hc | layer Δθ50 |
| Sample | (structure) | (structure) | (structure) | (dB) | (Oe) | (°) |
| Example 3-1 | NiFe (fcc) | Cr (bcc) | Ru (hcp) | 15.8 | 4761 | 3 |
| Comparative | NiFe (fcc) | Cr (bcc) | Cr (bcc) | — | 2541 | No peak |
| example 3-1 | | | | | | |
| Comparative | NiFe (fcc) | Cr (bcc) | Ni (fcc) | 13.2 | 4979 | 3.8 |
| example 3-2 | | | | | | |

The present invention can be applied to a perpendicular magnetic recording medium, a method of manufacturing the same, and a magnetic recording/reproducing apparatus using the magnetic recording medium.

1. A perpendicular magnetic recording medium comprising:
a non-magnetic substrate; and
at least a soft magnetic layer, an underlayer, an intermediate layer, and a perpendicular magnetic recording layer that are formed on the non-magnetic substrate in this order,
wherein the underlayer is a (111) crystal orientation layer having an fcc structure, and
the intermediate layer includes a (110) crystal orientation layer having a bcc structure and a (002) crystal orientation layer having an hcp structure in this order.

2. The magnetic recording medium according to claim 1,
wherein the (110) crystal orientation layer having the bcc structure includes 60 atomic % or more of Cr.

3. The magnetic recording medium according to claim 1, wherein the (110) crystal orientation layer having the bcc structure includes Cr, which is a main component, and at least one element selected from a group composed of Pt, Ir, Pd, Au, Ni, Al, Ag, Cu, Rh, Pb, Co, Fe, Mn, V, Nb, Ta, Mo, W, B, C, Si, Ga, In, Ti, Zr, Hf, Ru, and Re.

4. The magnetic recording medium according to claim 1, wherein the diameter of crystal particles of the (110) crystal orientation layer having the bcc structure is in the range of 3 nm to 10 nm.

5. The magnetic recording medium according to claim 1, wherein the thickness of the (110) crystal orientation layer having the bcc structure is in the range of 1 nm to 50 nm.

6. The magnetic recording medium according to claim 1, wherein a soft magnetic layer of the soft magnetic layer has an amorphous structure.

7. The magnetic recording medium according to claim 1, wherein the (111) crystal orientation layer having the fcc structure includes one alloy selected from a group composed of Ni, NiW, NiFe, NiV, and NiNb.

8. The magnetic recording medium according to claim 1, wherein the (002) crystal orientation layer having the hcp structure includes Ru or a Ru alloy.

9. The magnetic recording medium according to claim 1, wherein at least one layer of the perpendicular magnetic recording layer is an oxide-containing magnetic layer or a layer formed by continuously depositing Co and Pd.

10. A magnetic recording/reproducing apparatus comprising:
the magnetic recording medium according to claim 1; and
a magnetic head that records or reproduces information on or from the magnetic recording medium.

11. The magnetic recording medium according to claim 2, wherein the (110) crystal orientation layer having the bcc structure includes Cr, which is a main component, and at least one element selected from a group composed of Pt, Ir, Pd, Au, Ni, Al, Ag, Cu, Rh, Pb, Co, Fe, Mn, V, Nb, Ta, Mo, W, B, C, Si, Ga, In, Ti, Zr, Hf, Ru, and Re.

12. The magnetic recording medium according to claim 2, wherein the diameter of crystal particles of the (110) crystal orientation layer having the bcc structure is in the range of 3 nm to 10 nm.

13. The magnetic recording medium according to claim 2, wherein the thickness of the (110) crystal orientation layer having the bcc structure is in the range of 1 nm to 50 nm.

14. The magnetic recording medium according to claim 2, wherein a soft magnetic layer of the soft magnetic layer has an amorphous structure.

15. The magnetic recording medium according to claim 2, wherein the (111) crystal orientation layer having the fcc structure includes one alloy selected from a group composed of Ni, NiW, NiFe, NiV, and NiNb.

16. The magnetic recording medium according to claim 2, wherein the (002) crystal orientation layer having the hcp structure includes Ru or a Ru alloy.

17. The magnetic recording medium according to claim 2, wherein at least one layer of the perpendicular magnetic recording layer is an oxide-containing magnetic layer or a layer formed by continuously depositing Co and Pd.
